(19) United States
(12) Patent Application Publication
(10) Pub. No.: US 2010/0222450 A1
(43) Pub. Date: Sep. 2, 2010

(54) PIGMENT-DISPERSION COMPOSITION AND COLORED PHOTOSENSITIVE COMPOSITION

(76) Inventors: Koichi Sugihara, Shizuoka (JP); Shigetomo Tsujihata, Kanagawa (JP)

Correspondence Address: BIRCH STEWART KOLASCH & BIRCH, PO BOX 747, FALLS CHURCH, VA, 22040-0747, US

(21) Appl. No.: 12/161,509

(22) PCT Filed: Feb. 7, 2007
(86) PCT No.: PCT/JP2007/052537

§ 371 Date: Jul. 18, 2008

(30) Foreign Application Priority Data
Feb. 8, 2006 (JP) 2006-031483

(51) Int. Cl. C08F 2/46; C08L 33/00; C08L 51/00

(52) U.S. Cl. 522/182; 524/556; 524/504

(57) ABSTRACT

A pigment-dispersion composition, which has: a graft polymer having an acid group and organic pigment particles formed by mixing a solution in which an organic pigment is dissolved in a good solvent with a poor solvent for the organic pigment, the poor solvent having compatibility with the good solvent.

### TECHNICAL FIELD

The present invention relates to a pigment-dispersion composition and a colored photosensitive composition. More specifically, the present invention relates to a pigment-dispersion composition and a colored photosensitive composition prepared therefrom that shows good dispersion stability and can be applied to a color filter for a color liquid crystal display or the like.

### BACKGROUND ART

Pigments have been used in a variety of fields because each of them has a bright color tone, and high in coloring power and weather resistance. For a practically important material among them, in general, a fine particle form of pigments is frequently employed, i.e., the pigments are formed into fine-particles preventing them from aggregation so that bright their color tone and high coloring power can be obtained. In this regard, in many cases, when the fine pigment particles are reduced in size by a physical method such as salt milling, the dispersion of fine pigment particles results in a high viscosity liquid. Consequently, when the pigment dispersion liquid is prepared on an industrial scale, there arise the following problems: the pigment-dispersion liquid prepared can not be taken out of a dispersion machine, the dispersion liquid can not be transported through a pipeline, and further the dispersion liquid is solidified into a gel form during its storage so that the liquid can not be handled any more.

Therefore, conventionally, to obtain a pigment-dispersion liquid or colored photosensitive composition improved in fluidity and dispersibility, it has been attempted to modify the surface of an organic pigment (see, for example, JP-A-11-269401 (“JP-A” means unexamined published Japanese patent application) and JP-A-11-302553) and to use various dispersing agents (see, for example, JP-A-08-48890 and JP-A-2000-239554). Further, reprecipitation of forming particles is disclosed in which a sample dissolved in a solvent is injected into the other solvent under stirring condition at a controlled temperature (see, for example, JP-A-2004-123853).

When the colored photosensitive composition is used to form a colored image, its general procedure involves: applying a liquid of the composition onto a substrate to form a layer thereof; and subjecting the layer to exposure and development. In this procedure, since an alkali aqueous solution has less environmental influence, it is often used as a developer to be used at the time of the development treatment. Hence, the colored photosensitive composition is required to allow to use the alkali developing solution for the development. In addition to it, a solvent (dispersion medium for a pigment) for use in the application liquid of the colored photosensitive composition is required to be easily dried after the application.

Further, it is generally required that a layer formed by the colored photosensitive composition is extremely thin and that the layer shows a high coloring density even in such small thickness. Accordingly, e.g., an organic pigment is to be shaped in fine particles of highly and uniformly reduced in size and dispersed in an organic solvent.

However, at present, there is no pigment-dispersion satisfying those requirements with excellent dispersibility, fluidity, and the like. In particular, the particles obtained by the above reprecipitation process have large surface areas, and thereby they can hardly attain excellent dispersibility and fluidity required. Thus, neither a pigment dispersion composition nor a colored photosensitive composition having such properties has been developed.

### DISCLOSURE OF INVENTION

The present invention contemplates to provide a pigment-dispersion composition and colored photosensitive composition, having fine organic pigment particles, which can show stability and good dispersibility. Further, the present invention contemplates to provide the above compositions which can show excellent fluidity with high coloring power, further which can possess alkali development suitability, and accordingly they can suitably be used in a wide range of industrial applications.

According to the present invention, there is provided the following means:

(1) A pigment-dispersion composition, comprising:

a graft polymer having an acid group, and

organic pigment particles formed by mixing a solution in which an organic pigment is dissolved in a good solvent with a poor solvent for the organic pigment, the poor solvent having compatibility with the good solvent.

(2) The pigment-dispersion composition according to the item (1), wherein the graft polymer is a copolymer which is formed at least by copolymerization components comprising a polymerizable monomer component having the acid group and a polymerizable oligomer component having an ethylenically unsaturated double bond at any one of its terminals.
(3) The pigment-dispersion composition according to the item (2), wherein the graft polymer comprises 15 to 98 mass % of a unit derived from the polymerizable oligomer and 1 to 40 mass % of a unit derived from the polymerizable monomer having the acid group.
(4) The pigment-dispersion composition according to the item (2) or (3), wherein the polymerizable oligomer has a number-average molecular weight of 1,000 to 20,000, and the oligomer has a (meth)acryloyl group at any one of its terminals.
(5) The pigment-dispersion composition according to any one of the items (2) to (4), wherein the composition comprises the graft polymer in an amount of 10 to 80 parts by mass with respect to 100 parts by mass of the organic pigment.
(6) The pigment-dispersion composition according to any one of the items (1) to (5), further comprising a nitrogen-containing polymer.
(7) The pigment-dispersion composition according to the item (6), wherein the nitrogen-containing polymer is water-soluble.
(8) The pigment-dispersion composition according to any one of the items (1) to (7), wherein the organic pigment particles are dispersed in an organic solvent.
(9) The pigment-dispersion composition according to any one of the items (1) to (8), wherein the acid group is a group selected from the group consisting of a carboxyl group and a phosphoric acid group.
(10) A colored photosensitive composition, comprising: the composition according to any one of the items (1) to (9), a polyfunctional monomer having two or more ethylenically unsaturated double bonds, and a photopolymerization initiator.

According to the present invention, a pigment-dispersion composition and a colored photosensitive composition, having fine organic pigment particles, which show stability and good dispersibility can be provided. Further, according to the present invention, the above compositions which show excellent fluidity with high coloring power, further possess suitability for alkali development, and accordingly they can be suitably used in a wide range of industrial applications.

Other and further features and advantages of the invention will appear more fully from the following description, appropriately referring to the accompanying drawings.

### BRIEF DESCRIPTION OF DRAWINGS

FIG. 1 is an explanatory drawing showing an embodiment of an ultrafiltration device for use in the present invention.

81 a tank for storing a dispersed product
82 a circulation pump
83 an ultrafiltration module
84 a flow meter for measuring replenishment pure water
85 a flow meter for measuring permeated water
86 a reverse-direction washing pump

### BEST MODE FOR CARRYING OUT INVENTION

Hereinafter, the present invention will be described in detail.

The pigment-dispersion composition of the present invention contains organic pigment particles and a graft polymer having an acid group.

The organic pigment for use in the present invention is not limited in the color tone thereof. Specifically, examples thereof include a perylene, perynone, quinacridone, quinacridonequinone, anthraquinone, anthanthrone, benzimidazolone, condensed disazo, disazo, azo, indanthrone, plithalocyanine, triaryl carbonium, dioxazine, aminoanthraquinone, diketopyrrolopyrrole, thioindigo, isoindoline, isoindolinone, pyranthrone or isoviolanthrone-compound pigment, or a mixture thereof.

More specifically, examples of the organic pigment include perylene-compound pigments, such as C.I. Pigment Red 190 (C.I. No. 71140), C.I. Pigment Red 224 (C.I. No. 71127), C.I. Pigment Violet 29 (C.I. No. 71129), or the like; perynone-compound pigments, such as C.I. Pigment Orange 43 (C.I. No. 71105), C.I. Pigment Red 194 (C.I. No. 71100) or the like; quinacridone-compound pigments, such as C.I. Pigment Violet 19 (C.I. No. 73900), C.I. Pigment Violet 42, C.I. Pigment Red 122 (C.I. No. 73915), C.I. Pigment Red 192, C.I. Pigment Red 202 (C.I. No. 73907), C.I. Pigment Red 207 (C.I. Nos. 73900, 73906), C.I. Pigment Red 209 (C.I. No. 73905) or the like; quinacridonequinone-compound pigments, such as C.I. Pigment Red 206 (C.I. No. 73900/73920), C.I. Pigment Orange 48 (C.I. No. 73900/73920), C.I. Pigment Orange 49 (C.I. No. 73900/73920), or the like; anthraquinone-compound pigments, such as C.I. Pigment Yellow 147 (C.I. No. 60645) or the like; anthanthrone-compound pigments, such as C.I. Pigment Red 168 (C.I. No. 59300) or the like; benzimidazolone-compound pigments, such as C.I. Pigment Brown 25 (C.I. No. 12510), C.I. Pigment Violet 32 (C.I. No. 12517), C.I. Pigment Yellow 180 (C.I. No. 21290), C.I. Pigment Yellow 181 (C.I. No. 11777), C.I. Pigment Orange 62 (C.I. No. 11775), C.I. Pigment Red 185 (C.I. No. 12516), or the like; condensed disazo-compound pigments, such as C.I. Pigment Yellow 93 (C.I. No. 20710), C.I. Pigment Yellow 94 (C.I. No. 20038), C.I. Pigment Yellow 95 (C.I. No. 20034), C.I. Pigment Yellow 128 (C.I. No. 20037), C.I. Pigment Yellow 166 (C.I. No. 20035), C.I. Pigment Orange 34 (C.I. No. 21115), C.I. Pigment Orange 13 (C.I. No. 21110), C.I. Pigment Orange 31 (C.I. No. 20050), C.I. Pigment Red 144 (C.I. No. 20735), C.I. Pigment Red 166 (C.I. No. 20730), C.I. Pigment Red 220 (C.I. No. 20055), C.I. Pigment Red 221 (C.I. No. 20065), C.I. Pigment Red 242 (C.I. No. 20067), C.I. Pigment Red 248, C.I. Pigment Red 262, C.I. Pigment Brown 23 (C.I. No. 20060), or the like; disazo-compound pigments, such as C.I. Pigment Yellow 13 (C.I. No. 21100), C.I. Pigment Yellow 83 (C.I. No. 21108), C.I. Pigment Yellow 188 (C.I. No. 21094), or the like; azo-compound pigments, such as C.I. Pigment Red 187 (C.I. No. 12486), C.I. Pigment Red 170 (C.I. No. 12475), C.I. Pigment Yellow 74 (C.I. No. 11714), C.I. Pigment Yellow 150 (C.I. No. 48545), C.I. Pigment Red 48 (C.I. No. 15865), C.I. Pigment Red 53 (C.I. No. 15585), C.I. Pigment Orange 64 (C.I. No. 12760), C.I. Pigment Red 247 (C.I. No. 15915), or the like; indanthrone-compound pigments, such as C.I. Pigment Blue 60 (C.I. No. 69800), or the like; phthalocyanine-compound pigments, such as C.I. Pigment Green 7 (C.I. No. 74260), C.I. Pigment Green 36 (C.I. No. 74265), Pigment Green 37 (C.I. No. 74255), Pigment Blue 16 (C.I. No. 74100), C.I. Pigment Blue 75 (C.I. No. 74160:2), 15 (C.I. No. 74160), or the like; triaryl carbonium-compound pigments, such as C.I. Pigment Blue 56 (C.I. No. 42800), C.I. Pigment Blue 61 (C.I. No. 42765:1), or the like; dioxazine-compound pigments, such as C.I. Pigment Violet 23 (C.I. No. 51319), C.I. Pigment Violet 37 (C.I. No. 51345), or the like; aminoanthraquinone-compound pigments, such as C.I. Pigment Red 177 (C.I. No. 65300), or the like; diketopyrrolopyrrole-compound pigments, such as C.I. Pigment Red 254 (C.I. No. 56110), C.I. Pigment Red 255 (C.I. No. 561050), C.I. Pigment Red 264, C.I. Pigment Red 272 (C.I. No. 561150), C.I. Pigment Orange 71, C.I. Pigment Orange 73, or the like; thioindigo-compound pigments, such as C.I. Pigment Red 88 (C.I. No. 73312), or the like; isoindoline-compound pigments, such as C.I. Pigment Yellow 139 (C.I. No. 56298), C.I. Pigment Orange 66 (C.I. No. 48210), or the like; isoindolinone-compound pigments, such as C.I. Pigment Yellow 109 (C.I. No. 56284), C.I. Pigment Orange 61 (C.I. No. 11295), or the like; pyranthrone-compound pigments, such as C.I. Pigment Orange 40 (CI. No. 59700), C.I. Pigment Red 216 (C.I. No. 59710), or the like; or isoviolanthrone-compound pigments, such as C.I. Pigment Violet 31 (C.I. No. 60010), or the like.

Preferred organic pigments are quinacridone-compound pigments, diketopyrrolopyrrole-compound pigments, phthalocyanine-compound pigments, dioxazine-compound pigments, aminoanthraquinone-compound pigments, or azo-compound pigments.

In the composition of the present invention, a mixture of two or more organic pigments, a solid solution of organic pigments, or a combination thereof may also be used.

The graft polymer having an acid group to be used in the present invention is preferably a polymer having a main chain to which a site having the acid group is covalently bonded as a side chain directly or through a spacer site. Examples of the graft polymer include, but not limited to, in respect of copolymerization components; a graft polymer (a) constituted of at least a polymerizable monomer component (a1) having an acid group and a polymerizable oligomer component (a2) having an ethylenically unsaturated double bond at a terminal; a graft polymer (b) obtained by adding a component serving as a graft site to a (co)polymer having an acid group at any one of its side chains by using a polymer reaction; and a graft polymer (c) obtained by performing a polymerization reaction by using a (co)polymer having an acid group at any one of its side chains as an origin to form a graft site. The graft polymer having an acid group in the present invention can be synthesized with reference to, for example, an ordinal polymerization or a copolymerization between a polymerizable monomer having an acid group and a polymerizable oligomer having an ethylenically unsaturated double bond at a terminal. In consideration of suitability for synthesis (for example, a mild reaction condition, the ease of synthesis, or a low raw material cost), the graft polymer having the acid group to be used in the present invention is preferably a copolymer (a), that is synthesized by a copolymerization reaction between a polymerizable monomer (a1) having the acid group and a polymerizable oligomer (a2) having an ethylenically unsaturated double bond at a terminal.

A copolymer (a) includes: [1] a copolymer consisting of acrylic acid and/or methacrylic acid (a1), and a polymerizable oligomer (a2) having an ethylenically unsaturated double bond at a terminal, or [2] a copolymer consisting of acrylic acid and/or methacrylic acid (a1), a polymerizable oligomer (a2) having an ethylenically unsaturated double bond at a terminal, and any other monomer (a3) copolymerizable with them.

The acid group of the polymerizable monomer (a1) is an acid dissociation constant pKa of 10 or less. Specifically, it includes an acid group having a hydrogen atom bonded to an oxygen atom such as a carboxyl group, a phenolic hydroxyl group, a phosphoric acid, or a sulfonic group; an acid group having a hydrogen atom bonded to a carbon atom adjacent to an electron-withdrawing group such as a carbonyl group such as an active methylene group or an active methine group; and an acid group having a hydrogen atom bonded to a nitrogen atom such as a sulfoneamide group or a sulfonylamide group. Of these acid groups, an acid group having a hydrogen atom bonded to an oxygen atom is preferable in the present invention, and specific examples of the group include a carboxyl group and a phosphoric acid group (phosphate group). In addition, preferable examples of the polymerizable monomer include acrylic acid and methacrylic acid.

In the polymerizable oligomer (a2) (which may hereinafter be referred to as “macromonomer”) having an ethylenically unsaturated double bond at a terminal, it is preferable that the oligomer has an ethylenically unsaturated double bond, or such a group, at only one of both the terminals of the oligomer.

The number-average molecular weight (Mn) of the polymerizable oligomer in terms of polystyrene is preferably 1,000 to 20,000, and more preferably 2,000 to 10,000. When the number-average molecular weight is less than 1,000, the steric repulsion effect of the oligomer as a pigment dispersing agent is not sufficient in some cases. When the number-average molecular weight exceeds 20,000, it takes a long period of time for the oligomer to adsorb to a pigment owing to a steric effect in some cases.

General examples of a main chain of the oligomer include homopolymers or copolymers each formed of at least one kind of a monomer selected from an alkyl (meth)acrylate, a hydroxyalkyl (meth)acrylate, styrene, acrylonitrile, vinyl acetate, and butadiene. Of these, a homopolymer or copolymer of an alkyl (meth)acrylate, a homopolymer or copolymer of a hydroxyalkyl (meth)acrylate, polystyrene, or the like is preferable. In the present invention, each of these oligomers may be substituted by a substituent, and examples of the substituent include, but not particularly limited to, a halogen atom and a hydroxyl group.

Preferable examples of the group having an ethylenically unsaturated double bond include a (meth)acryloyl group and a vinyl group. Of these, a (meth)acryloyl group is particularly preferable.

In the present invention, among these polymerizable oligomers, an oligomer represented by the following formula (1) is preferable.

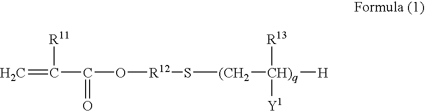

In the formula (1), R¹¹ and R¹³ each represent a hydrogen atom or a methyl group, R¹² represents an alkylene group which has 1 to 8 carbon atoms and which may be substituted by an alcoholic hydroxyl group, or preferably represents an alkylene group having 2 to 4 carbon atoms, Y¹ represents a phenyl group, a phenyl group having an alkyl group having 1 to 4 carbon atoms, or —COOR¹⁴ (where R¹⁴ represents an alkyl group which has 1 to 6 carbon atoms and which may be substituted by an alcoholic hydroxyl group or a halogen, a phenyl group, or an arylalkyl group having 7 to 10 carbon atoms), or preferably represents a phenyl group or —COOR¹⁴ (where R¹⁴ represents an alkyl group which has 1 to 4 carbon atoms and which may be substituted by an alcoholic hydroxyl group), and q represents 20 to 200.

Specific examples of the polymerizable oligomer include poly-2-hydroxyethyl (meth)acrylate, polystyrene, polymethyl (meth)acrylate, poly-n-butyl (meth)acrylate, poly-1-butyl (meth)acrylate, and a copolymer thereof having a (meth)acryloyl group bonded to one of its molecular terminals.

The polymerizable oligomer may be a commercially available product, or may be appropriately synthesized. Examples of the commercially available product include: a single-terminal-methacryloylated polystyrene oligomer (Mn=6,000, trade name: AS-6, manufactured by TOAGOSEI CO., LTD.); a single-terminal-methacryloylated polymethyl methacrylate oligomer (Mn=6,000, trade name: AA-6, manufactured by TOAGOSEI CO., LTD.); a single-terminal-methacryloylated poly-n-butyl acrylate oligomer (Mn=6,000, trade name: AB-6, manufactured by TOAGOSEI CO., LTD.); a single-terminal-methacryloylated polymethyl methacrylate/2-hydroxyethyl methacrylate oligomer (Mn=7,000, trade name: AA-714, manufactured by TOAGOSEI CO., LTD.); a single-terminal-methacryloylated polybutyl methacrylate/2-hydroxyethyl methacrylate oligomer (Mn=7,000, trade name: 707 S, manufactured by TOAGOSEI CO., LTD.); and a single-terminal-methacryloylated poly-2-ethylhexyl methacrylate/2-hydroxyethyl methacrylate oligomer (Mn=7,000, trade name: AY-707 S or AY-714 S, manufactured by TOAGOSEI CO., LTD.).

A preferable specific example of the polymerizable oligomer in the present invention is at least one kind of an oligomer selected from a polymer of an alkyl (meth)acrylate and a copolymer of an alkyl (meth)acrylate and polystyrene, the oligomer having a number average molecular weight of 1,000 to 20,000, and the oligomer having a (meth)acryloyl group at a terminal.

In the present invention, the graft polymer (a) is preferably a copolymer which has the monomer (a1) and the polymerizable oligomer (a2), if necessary, further any other monomer (a3) copolymerizable with them. Examples of the other monomer (a3) include: aromatic vinyl compounds (such as styrene, α-methylstyrene, and vinyltoluene); alkyl (meth)acrylates (such as methyl (meth)acrylate, ethyl (meth)acrylate, n-butyl (meth)acrylate, and i-butyl (meth)acrylate); alkylaryl (meth)acrylates (such as benzyl (meth)acrylate and glycidyl (meth)acrylate); vinyl cyanides (such as (meth)acrylonitrile and α-chloroacrylonitrile); and aliphatic conjugated dienes (such as 1,3-butadiene and isoprene). Of these, the alkyl (meth)acrylates and the alkylaryl (meth)acrylates are preferable. A copolymerization ratio is as follows: the content of the polymerizable monomer (a1) having the acid group is 1 to 40 mass %, or preferably 2 to 35 mass %, the content of the polymerizable oligomer (a2) is 15 to 98 mass %, or preferably 30 to 95 mass %, and the content of the other monomer (a3) is 0 to 90 mass %, or preferably 0 to 80 mass %.

Examples of the copolymer are shown below:

(1) a copolymer of (meth)acrylic acid/terminal-methacryloylated polymethyl (meth)acrylate;
(2) a copolymer of (meth)acrylic acid/terminal-methacryloylated polybutyl (meth)acrylate;
(3) a copolymer of (meth)acrylic acid/terminal-methacryloylated polystyrene;
(4) a copolymer of (meth)acrylic acid/a copolymer of terminal-methacryloylated methyl (meth)acrylate and 2-hydroxyethyl (meth)acrylate;
(5) a copolymer of (meth)acrylic acid/a copolymer of terminal-methacryloylated butyl (meth)acrylate and 2-hydroxyethyl (meth)acrylate;
(6) a copolymer of (meth)acrylic acid/a copolymer of terminal-methacryloylated 2-ethylhexyl (meth)acrylate and 2-hydroxyethyl (meth)acrylate;
(7) a copolymer of (meth)acrylic acid/terminal-methacryloylated polymethyl (meth)acrylate/benzyl methacrylate;
(8) a copolymer of (meth)acrylic acid/a copolymer of terminal-methacryloylated methyl (meth)acrylate and 2-hydroxyethyl (meth)acrylate/benzyl methacrylate;
(9) a copolymer of (meth)acrylic acid/a copolymer of terminal-methacryloylated butyl (meth)acrylate and 2-hydroxyethyl (meth)acrylate/benzyl methacrylate; and
(10) a copolymer of (meth)acrylic acid/terminal-methacryloylated polymethyl (meth)acrylate/methyl (meth)acrylate.

In addition, the above graft polymers replacing the acid group (e.g. (meth)acrylic acid) in the above examples with the following polymerizable monomers can also be given as preferable examples.

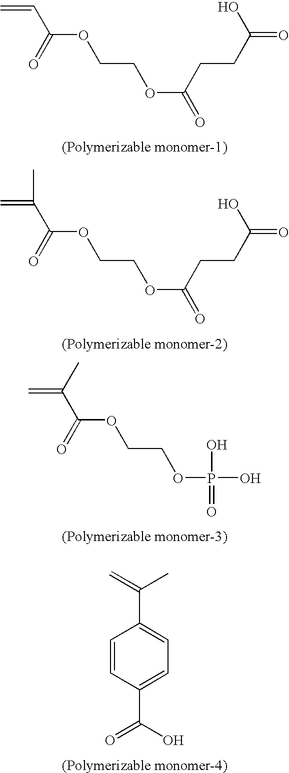

The graft polymer (a) can be obtained by radically polymerizing the polymerizable oligomer (a2), the polymerizable monomer (a1) having an acid group, and, as required, the other copolymerizable monomer (a3) in a solvent. A radical polymerization initiator is generally used at the time of the polymerization. Further, any one of the chain transfer agents (such as 2-mercaptoethanol and dodecylmercaptan) can also be used. The incorporation of the copolymer into the pigment-dispersion composition stabilizes the dispersion of the organic pigment. Synthesis examples of a graft polymer that can be suitably used in the present invention are shown below.

### Synthesis Example 1

15 parts by mass of 1-methoxy-2-propylacetate were introduced into a three-necked flask replaced with nitrogen gas, and were stirred with a three-one motor. The flask was heated while nitrogen gas was flowed into the flask so that the temperature inside the flask was increased to 78° C. The following monomer solution and the following initiator solution separately prepared were simultaneously dropped over 2 hours and 15 minutes.

### (Monomer Solution)

| | |
|---|---|
| Methacrylic acid | 3.0 parts by mass |
| Polymethyl methacrylate having a methacryloyl | 27.0 parts by mass |
| group at one of its terminals (number average | |
| molecular weight: 6,000, trade name: | |
| Macromonomer AA-6, manufactured by | |
| TOAGOSEI CO., LTD.) | |
| 1-methoxy-2-propylacetate | 45.0 parts by mass |

### (Initiator Solution)

| | | |
|---|---|---|
| 2,2-azobis(2,4-dimethylvaleronitrile) (trade name: | 0.04 | part by mass |
| V-65, manufactured by Wako Pure Chemical | | |
| Industries, Ltd.) | | |
| 1-methoxy-2-propylacetate | 9.6 | parts by mass |

After the monomer solution and the initiator solution had been dropped, 0.08 part by mass of 2,2-azobis(2,4-dimethylvaleronitrile) (trade name: V-65) was added to the solution in the flask, and, furthermore, the temperature inside the flask was held at 78° C. for 3 hours. After that, the flask was heated, and the temperature was held at 90° C. for 30 minutes. Next, the temperature of the solution in the flask was cooled to room temperature, whereby a polymer solution was obtained. The polymer solution had a solid content of 30 mass % and a polymerization yield of 98%. The mass-average molecular weight of the resultant polymer A (copolymer) was 20,000. The mass-average molecular weight was measured by using a gel permeation chromatograph (C-R4 A (trade name), manufactured by Shimadzu Corporation).

### Synthesis Example 2

A polymer B was prepared in the same manner as Synthesis Example 1, except that the following monomer solution and the following initiator solution were used in place of them in Synthesis Example 1.

### (Monomer Solution)

| | |
|---|---|
| Methacrylic acid | 4.8 parts by mass |
| Benzyl (meth)acrylate | 4.8 parts by mass |
| Polymethyl methacrylate having a methacryloyl | 20.4 parts by mass |
| group at one of its terminals (number average | |
| molecular weight: 6,000, trade name: | |
| Macromonomer AA-6, manufactured by | |
| TOAGOSEI CO., LTD.) | |
| 1-methoxy-2-propylacetate | 45.0 parts by mass |

### (Initiator Solution)

| | | |
|---|---|---|
| 2,2-azobis(2,4-dimethylvaleronitrile) (trade name: | 0.16 | part by mass |
| V-65, manufactured by Wako Pure Chemical | | |
| Industries, Ltd.) | | |
| 1-methoxy-2-propylacetate | 7.2 | parts by mass |

### Synthesis Example 3

A polymer C was prepared in the same manner as Synthesis Example 1, except that the following monomer solution was used in place of the monomer solution in Synthesis Example 1.

### (Monomer Solution)

| | |
|---|---|
| Acrylic acid | 30 parts by mass |
| Polymethyl methacrylate having a methacryloyl | 27.0 parts by mass |
| group at one of its terminals (number average | |
| molecular weight: 6,000, trade name: | |
| Macromonomer AA-6, manufactured by | |
| TOAGOSEI CO., LTD.) | |
| 1-methoxy-2-propylacetate | 45.0 parts by mass |

The mass-average molecular weight of the graft polymer is preferably 5,000 to 200,000. When the mass-average molecular weight is too small, there may arise a problem in the formation of a coating film upon use of the graft polymer as a colored photosensitive composition. When the mass average molecular weight is too large, the viscosity of a colored photosensitive composition increases in mine cases.

The content of the graft polymer in the pigment-dispersion composition is generally 10 to 200 parts by mass, preferably 10 to 150 parts by mass, and particularly preferably 10 to 80 parts by mass with respect to 100 parts by mass of the pigment. When the content is excessively large, a steric repulsion effect cannot be obtained in some cases. When the content is excessively small, the viscosity of a dispersion liquid increases in some cases.

The pigment-dispersion composition of the present invention preferably further contains a nitrogen-containing polymer compound. The nitrogen-containing polymer compound is preferably a polymer (polycondensate or polyaddition product) having a molecular weight of 500 or more and having a group such as an amine, amide, imine, imide, carbodiimide, hydrazide, or urethane group in any one of its repeating structures, more preferably one having a molecular weight of 1,000 to 400,000, and particularly preferably one having a molecular weight of 5,000 to 80,000. In the present invention, the term “molecular weight” of a polymer as used herein refers to a mass-average molecular weight unless otherwise stated. Examples of a method of measuring the molecular weight of a polymer include a chromatography method, a viscosity method, a light scattering method, and a sedimentation velocity method. In the present invention, a mass-average molecular weight measured by the chromatography method is used unless otherwise stated.

Examples of the nitrogen-containing polymer compound include: polyamides such as poly-β-alanine, nylon 12, nylon 4.6, nylon 6, nylon 6.6, nylon 6.10, and a terpolymer of them (6.6/6.10/6); homopolymers, copolymers, or crosslinked products of polyallylamine, polyethyleneimine, acrylamide, or methacrylamide each produced by the polymerization of a compound having a vinyl group such as vinyl polymers including polyacrylamide, polymethacrylamide, polyvinyl pyrrolidone, and poly-4-vinylpyridine, and the copolymers and crosslinked products of the vinyl polymers with other vinyl compounds; various polyurethanes synthesized by using a diisocyanate compound such as 4,4′-methylenebis(phenylisocyanate), tolylene diisocyanate, isophorone diisocyanate, and 1,6-hexamethylenediisocyanate, with a low-molecular-weight diol each having 2 to 4 carbon atoms or a high-molecular-weight diol such as polytetramethylene glycol, polyethylene glycol, and polybutylene adipate dial; and amine polycondensates each synthesized by the polycondensation of formaldehyde and an amine compound such as a urea resin, a melamine resin, and a benzoguanamine resin.

The amount of the nitrogen-containing polymer compound in the pigment-dispersion composition is preferably 0.01 to 200 parts by mass, more preferably 0.1 to 100 parts by mass, or particularly preferably 0.1 to 50 parts by mass with respect to 100 parts by mass of the pigment.

The nitrogen-containing polymer compound in the present invention is preferably water-soluble. The term “water-soluble” as used herein refers to a state where 1 g or more of the compound are dissolved in 100 g of water at room temperature. Examples of a preferable water-soluble, nitrogen-containing polymer compound include polyvinyl pyrrolidone, poly-N-vinylacetamide, and polyacrylamide.

The pigment-dispersion composition of the present invention can also contain a pigment dispersing agent. The composition preferably contains a pigment dispersing agent particularly when an organic pigment free of any surface modifier is used as the organic pigment serving as a raw material. The pigment dispersing agent can contain an anionic, cationic, amphoteric, nonionic, or pigment-based pigment dispersing agent.

The pigmentary dispersing agent is defined as a dispersing agent derived from an organic pigment as a parent material, and prepared by chemically modifying a structure of the parent material. Examples of the pigmentary dispersing agent include sugar-containing pigmentary dispersing agents, piperidyl-containing pigmentary dispersing agents, naphthalene- or perylene-derivative pigmentary dispersing agents, pigmentary dispersing agents having a functional group linked through a methylene group to a pigment parent structure, pigmentary dispersing agents (parent structure) chemically modified with a polymer, pigmentary dispersing agents having a sulfonic acid group, pigmentary dispersing agents having a sulfonamido group, pigmentary dispersing agents having an ether group, and pigmentary dispersing agents having a carboxylic acid group, carboxylic acid ester group or carboxamido group.

A compound represented by formula (I) described in JP-A-2000-239554 is also preferably used.

The content of the pigment dispersing agent is preferably from 0.1 to 1,000 parts by mass, more preferably from 1 to 500 parts by mass, and further preferably from 2 to 100 parts by mass, to 100 parts by mass of the pigment, to further improve the uniform dispersibility and storage stability of the pigment. If the content of the dispersing agent is too small, the dispersion stability of the organic pigment fine particles may not be improved, in some cases.

The pigment-dispersion composition of the present invention can contain an alkali-soluble binder having an acid group. The alkali-soluble binder having an acid group (which may hereinafter be simply referred to as “binder”) in the pigment-dispersion composition of the present invention is preferably a polymer having a polar group such as a carboxylic acid group or a carboxylate group at its side chain. Examples of the polymer include a methacrylic acid copolymer, an acrylic acid copolymer, an itaconic acid copolymer, a crotonic acid copolymer, a maleic acid copolymer, and a partially esterified maleic acid copolymer described in, for example, JP-A-59-44615, JP-B-54-34327 (“JP-B” means examined Japanese patent publication), JP-B-58-12577, JP-B-54-25957, JP-A-59-53836, and JP-A-59-71048. The examples further include a cellulose derivative having a carboxylic acid group at its side chain. In addition to the foregoing, a product obtained by adding a cyclic acid anhydride to a polymer having a hydroxyl group can also be preferably used. In addition, particularly preferable examples of the binder include a copolymer of benzyl (meth)acrylate and (meth)acrylic acid and a multi-component copolymer of benzyl (meth)acrylate, (meth)acrylic acid, and any other monomer described in U.S. Pat. No. 4,139,391. Each of these binder polymers each having a polar group may be used alone, or may be used in combination with an ordinary film formable polymer so that they are used in a state of a composition. The binder polymer is added in an amount of generally 10 to 200 parts by mass, and preferably 25 to 100 parts by mass with respect to 100 parts by mass of the organic pigment.

When the alkali-soluble binder having an acid group is a polymer compound, the number of acid groups in the polymer compound is not particularly limited; when the number of repeating units in one molecule is set to 100, the number of repeating units each having an acid group is preferably 5 to 100, and more preferably 10 to 100. In addition, a polymerization ratio between (1) a repeating unit derived from a compound having a carboxyl group and (2) a repeating unit derived from the compound having a carboxylate group is preferably as follows: a ratio of the repeating unit (1) is 5 to 40 mol %, a ratio of the repeating unit (2) is 40 to 90 mol %, and a ratio of a repeating unit(s) except the repeating units (1) and (2) is 25 mol % or less. In addition, the molecular weight of the alkali-soluble binder polymer compound having an acid group is preferably 3,000 to 1,000,000, more preferably 4,000 to 200,000, and particularly preferably 5,000 to 80,000.

In the present invention, the pigment-dispersion composition is preferably dispersed in an organic solvent. The solvent is not particularly limited, and can be appropriately selected. Examples of the solvents include: (poly)alkylene glycol monoalkyl ethers such as ethylene glycol monomethyl ether, ethylene glycol monoethyl ether, propylene glycol monomethyl ether, propylene glycol monoethyl ether, diethylene glycol monomethyl ether, and ethylene glycol monoethyl ether, and acetates of the ethers; acetates such as ethyl acetate, n-propyl acetate, i-propyl acetate, n-butyl acetate, and i-butyl acetate; aromatic hydrocarbons such as benzene, toluene, and xylene; ketones such as methyl ethyl ketone, acetone, methyl isobutyl ketone, and cyclohexanone; and alcohols such as ethanol, propanol, butanol, hexanol, cyclohexanol, ethylene glycol, diethylene glycol, and glycerin.

These solvents may be used alone, or used in combination thereof. Of these, the alkylene glycol monoalkyl ethers and the acetates thereof, the acetates, methyl ethyl ketone, and the like are preferable.

The content of the solvent in the pigment-dispersion composition is generally 10 to 1,000 parts by mass, and preferably 20 to 500 parts by mass with respect to 100 parts by mass of the pigment-dispersion composition. When the content is too small, the viscosity of the pigment-dispersion composition increases in some cases. When the content is too large, for example, it may become difficult to secure a space for storage of the composition.

Next, the formation of organic pigment particles will be described.

The organic pigment particles contained in the composition of the present invention are formed by a method in which an organic pigment solution prepared by dissolving an organic pigment in a good solvent and a poor solvent for the organic pigment are mixed (In this invention, “good solvent” means a solvent good to dissolve an organic pigment therein, in contrast, “poor solvent” means a solvent poor to dissolve the organic pigment therein.). In this connection, it is added that a good solvent and a poor solvent may be chosen for combination under the condition that the solvents chosen show a certain difference between their solubility for the organic pigment that is sufficient to carry out the steps to form the organic pigment particles in the composition of the present invention.

First, the good solvent for dissolving the organic pigment will be described.

The good solvent is not particularly limited as long as it can dissolve the organic pigment to be used, and is compatible, or uniformly mixed, with the poor solvent to be used at the time of the production of the organic pigment particles. The solubility of the organic pigment in the good solvent in the present invention, is generally 0.1 mass % or more, preferably 0.2 mass % or more, and more preferably 0.5 mass % or more. The solubility may be solubility in the case where the organic pigment is dissolved in the presence of an acid or an alkali. Compatibility, or uniform mixing property, between the poor solvent and the good solvent is such that the amount of the good solvent dissolved in the poor solvent is preferably 30 mass % or more, and more preferably 50 mass % or more.

Examples of the good solvents include aqueous solvents (e.g., water, aqueous hydrochloric acid solution, and aqueous sodium hydroxide solution), alcohol compound solvents, amide compound solvents, ketone compound solvents, ether compound solvents, aromatic compound solvents, carbon disulfide, aliphatic compound solvents, nitrile compound solvents, sulfoxide compound solvents, halogen compound solvents, ester compound solvents, ionic solvents, the mixed solvents thereof, and the like. Preferable good solvents include aqueous solvents, alcohol compound solvents, ester compound solvents, sulfoxide compound solvents, and amide compound solvents; aqueous solvents, sulfoxide compound solvents, and amide compounds solvents are more preferable; sulfoxide compound solvents and amide compounds solvents are particularly preferable.

Examples of the amide compound solvent include N,N-dimethylformamide, 1-methyl-2-pyrrolidone, 2-pyrrolidinone, 1,3-dimethyl-2-imidazolidinone, ε-caprolactam, formamide, N-methylformamide, acetamide, N-methylacetamide, N,N-dimethylacetamide, N-methylpropaneamide, and hexamethylphosphoric triamide.

In addition, the concentration of the organic pigment solution prepared by dissolving the organic pigment in the good solvent is preferably in the range of the saturation concentration of the organic pigment with respect to the good solvent under a condition at the time of the dissolution to about one hundredth of the saturation concentration. The concentration is preferably, for example, 0.5 to 12 mass %, though the preferable value varies depending on the organic pigment to be used. The concentration is preferably 2 to 12 mass % when an additionally high yield is requested in view of an industrial production scale.

The condition under which the organic pigment solution is prepared is not particularly restricted, and can be selected from a range from a normal pressure condition to a subcritical or supercritical condition. The temperature at which the solution is prepared under normal pressure is preferably −10 to 150° C., more preferably −5 to 130° C., and particularly preferably 0 to 100° C.

In the present invention, the organic pigment, which is uniformly dissolved in the good solvent, is also preferably dissolved when the solvent is acidic or alkaline. In general, in the case of the organic pigment having in the molecule thereof a group dissociative under alkaline, the alkaline solvent is used, and in the case of the organic pigment having no group dissociative under alkaline but having in the molecule thereof many nitrogen atoms, to which protons easily adhere, the acidic solvent is used. For example, quinacridone-, diketopyrrolopyrrole-, and condensed disazo-series pigments are dissolved in the alkaline solvent, and a phthalocyanine-series pigment is dissolved in the acidic solvent.

Examples of a base that can be used in the case that the organic pigment is dissolved in alkaline solvent, include inorganic bases, such as lithium hydroxide, sodium hydroxide, potassium hydroxide, calcium hydroxide, and barium hydroxide; and organic bases, such as trialkylamine, diazabicycloundecene (DBU), and metal alkoxides.

The amount of the base to be used is not particularly limited, as long as the base in the amount can make the pigment be dissolved homogeneously. In the case of the inorganic base, the amount thereof is preferably from 1.0 to 30 mole equivalents, more preferably from 1.0 to 25 mole equivalents, and further preferably from 1 to 20 mole equivalents, to the organic pigment. In the case of the organic base, the amount thereof is preferably from 1.0 to 100 mole equivalents, more preferably from 5.0 to 100 mole equivalents, and further preferably from 20 to 100 mole equivalents, to the organic pigment.

Examples of an acid to be used in the case that the organic pigment is dissolved in the acidic solvent, include inorganic acids, such as sulfuric acid, hydrochloric acid, and phosphoric acid; and organic acids, such as acetic acid, trifluoroacetic acid, oxalic acid, methanesulfonic acid, and trifluoromethanesulfonic acid. Among these, the inorganic acids are preferable, and sulfuric acid is especially preferable.

The amount of the acid to be used is not particularly limited, as long as the acid in the amount can make the organic pigment be dissolved homogeneously. In many cases, the acid is used in a larger or more excessive amount than the base. Regardless the kind of the acid being an inorganic acid or an organic acid, the amount of the acid to be used is preferably from 3 to 500 mole equivalents, more preferably from 10 to 500 mole equivalents, and further preferably from 30 to 200 mole equivalents, to the organic pigment.

When an alkali or an acid is mixed with the organic solvent so that the mixture is used as a good solvent for the organic pigment, a solvent having high solubility for the alkali or the acid such as water or a lower alcohol can be added in a slight amount to the organic solvent in order that the alkali or the acid may be completely dissolved. The amount of water or the lower alcohol is preferably 50 mass % or less, or more preferably 30 mass % or less with respect to the total amount of the organic pigment solution. Specific examples thereof that can be used include water, methanol, ethanol, n-propanol, isopropanol, and butyl alcohol.

Next, the poor solvent for the organic pigment will be described.

The poor solvent for the organic pigment is not particularly limited as long as it is compatible, or uniformly mixed, with the good solvent for dissolving the organic pigment. The solubility of the organic pigment in the poor solvent in the present invention, is generally 0.05 mass % or less, preferably 0.02 mass % or less, and more preferably 0.01 mass % or less. The solubility may be solubility in the case where the organic pigment is dissolved in the presence of an acid or an alkali. In addition, compatibility or uniform mixing property, between the good solvent and the poor solvent is as described above in the section of the good solvent.

Examples of the poor solvents include aqueous solvents (e.g., water, aqueous hydrochloric acid solution, and aqueous sodium hydroxide solution), alcohol compound solvents, ketone compound solvents, ether compound solvents, aromatic compound solvents, carbon disulfide, aliphatic compound solvents, nitrile compound solvents, halogen compound solvents, ester compound solvents, ionic solvents, the mixed solvents thereof; and the like. Preferable poor solvents include aqueous solvents, alcohol compound solvents, and ester compound solvents; aqueous solvents are particularly preferably used for an ink jet.

Examples of the alcohol compound solvents include methanol, ethanol, isopropyl alcohol, n-propyl alcohol, 1-methoxy-2-propanol, and the like. Examples of the ketone compound solvents include acetone, methylethylketone, methylisobutylketone, cyclohexanone, and the like. Examples of ether compound solvents include dimethylether, diethylether, tetrahydrofuran and the like. Examples of the aromatic compound solvents include benzene, toluene, and the like. Examples of the aliphatic compound solvents include hexane, and the like. Examples of the nitrile compound solvents include acetonitrile, and the like. Examples of the halogen compound solvents include dichloromethane, trichloroethylene, and the like. Examples of the ester compound solvents include ethyl acetate, ethyl lactate, 2-(1-methoxy) propyl acetate, and the like. Examples of the ionic solvents include a salt of 1-butyl-3-methylimidazolium and PF₆, and the like.

In the present invention, a dispersing agent is preferably added to both or one of the organic pigment solution and the poor solvent to which the organic pigment solution is added for producing the organic pigment particles. It is also preferable to add a dispersant solution, which is independently prepared, at the time of the formation of the organic pigment particles. The dispersing agent has a function (1) that the dispersing agent is rapidly adsorbed on the surface of the precipitated pigment, to form fine pigment particles, and (2) that these particles are prevented from aggregating again.

In the present invention, as the dispersing agent, use can be made of an anionic, cationic, amphoteric, nonionic or pigmentary and low-molecular-weight or polymer dispersing agent.

The molecular weight of the polymer dispersing agent for use may be any value, as long as the dispersing agent can be uniformly dissolved in a solution, but the polymer dispersing agent preferably has a molecular weight of 1,000 to 2,000,000, more preferably of 5,000 to 1,000,000, still more preferably of 10,000 to 500,000, and particularly preferably of 10,000 to 100,000. (Concerning the present invention, the term “molecular weight” means a mass-average molecular weight, unless otherwise stated. Polymer compounds are polydispersion-series compounds and do not always have a single molecular weight or a single particle mass. Thus, their measured molecular weights should be represented by a certain type of average molecular weight. The three main types of the average molecular weight are: (1) number average molecular weight (Mn), (2) mass-average molecular weight (Mw) and (3) Z average molecular weight (Mz); and the relationship Mn<Mw<Mz can be established.)

In the present invention, a solvent for dissolving the polymer dispersing agent is not particularly limited as long as it can dissolve the polymer dispersing agent so that the resultant solution has a desired concentration. Examples of the solvent include aqueous solvents (e.g., water, aqueous hydrochloric acid solution, and aqueous sodium hydroxide solution), alcohol compound solvents, ketone compound solvents, ether compound solvents, aromatic compound solvents, carbon disulfide, aliphatic compound solvents, nitrile compound solvents, halogen compound solvents, ester compound solvents, ionic solvents, the mixed solvents thereof, and the like. Preferable solvents include aqueous solvents, alcohol compound solvents, and ester compound solvents.

In addition, the concentration of the polymer dispersant solution, which is appropriately set in accordance with, for example, the solubility of the polymer dispersing agent, is such that the amount of the polymer dispersing agent (when the dispersing agent is used in combination with another dispersing agent, the total amount of the dispersing agents) is preferably 1 to 90 mass %, more preferably 10 to 80 mass %, and particularly preferably 30 to 80 mass % with respect to the total amount of the solution.

Examples of the polymer dispersing agent include polyvinyl pyrrolidone, polyvinyl alcohol, polyvinyl methyl ether, polyethylene oxide, polyethylene glycol, polypropylene glycol, polyacrylamide, polyethylene imine, vinyl alcohol/vinyl acetate copolymer, partial-formal products of polyvinyl alcohol, partial-butyral products of polyvinyl alcohol, vinylpyrrolidone/vinyl acetate copolymer, polyethylene oxide/propylene oxide block copolymer, polyacrylic acid salts, polyvinyl sulfuric acid salts, poly(4-vinylpyridine) salts, polyamides, polyallylamine salts, condensed naphthalenesulfonic acid salts, styrene/acrylic acid salt copolymers, styrene/methacrylic acid salt copolymers, acrylic acid ester/acrylic acid salt copolymers, acrylic acid ester/methacrylic acid salt copolymers, methacrylic acid ester/acrylic acid salt copolymers, methacrylic acid ester/methacrylic acid salt copolymers, styrene/itaconic acid salt copolymers, itaconic acid ester/itaconic acid salt copolymers, vinylnaphthalene/acrylic acid salt copolymers, vinylnaphthalene/methacrylic acid salt copolymers, vinylnaphthalene/itaconic acid salt copolymers, cellulose derivatives, and starch derivatives. Besides, natural polymers can be used, examples of which include alginic acid salts, gelatin, albumin, casein, gum arabic, tragacanth gum, and ligninsulfonic acid salts. Polyvinyl pyrrolidone, polyacrylamide and polyethylene imine are particularly preferable. These polymer dispersing agents may be used alone or in combination of two or more thereof.

In the present invention, it is also preferable to use an anionic, cationic, amphoteric, nonionic, or pigment-based, low-molecular-weight dispersing agent in addition to the polymer dispersing agent. Such a low-molecular-weight dispersing agent can be added to both or one of the organic pigment solution and the poor solvent for the organic pigment. It is also preferable to add the dispersing agent to the polymer dispersant solution. The low-molecular-weight dispersing agents to be used in combination are described in detail in “Dispersion Stabilization of Pigment and Surface Treatment Technique/Evaluation” (published by Japan Association for International Chemical Information, on December 2001), pp. 29-46.

Examples of the anionic dispersing agent (anionic surfactant) include N-acyl-N-alkyltaurine salts, fatty acid salts, alkylsulfates, alkylbenzenesulfonates, alkylnaphthalenesulfonates, dialkylsulfosuccinates, alkylphosphates, naphthalenesulfonic acid/formalin condensates, and polyoxyethylenealkylsulfates. N-acyl-N-alkyltaurine salts are particularly preferable. As the N-acyl-N-alkyltaurine salts, those described in JP-A-3-273067 are preferable. These anionic dispersing agents may be used alone or in combination of two or more thereof.

Examples of the cationic dispersing agent (cationic surfactant) include quaternary ammonium salts, alkoxylated polyamines, aliphatic amine polyglycol ethers, aliphatic amines, diamines and polyamines derived from aliphatic amine and aliphatic alcohol, imidazolines derived from aliphatic acid, and salts of these cationic substances. These cationic dispersing agents may be used alone or in combination of two or more thereof.

The amphoteric dispersing agent is a dispersing agent having, in the molecule thereof, an anionic group moiety which the anionic dispersing agent has in the molecule, and a cationic group moiety which the cationic dispersing agent has in the molecule.

Examples of the nonionic dispersing agents (nonionic surfactant) include polyoxyethylenealkyl ethers, polyoxyethylenealkylaryl ethers, polyoxyethylene fatty acid esters, sorbitan fatty acid esters, polyoxyethylenesorbitan fatty acid esters, polyoxyethylenealkylamines, and glycerin fatty acid esters. Among these, polyoxyethylenealkylaryl ethers are preferable. These nonionic dispersing agents may be used alone or in combination of two or more thereof.

The pigmentary dispersing agent is defined as a dispersing agent derived from an organic pigment as a parent material, and prepared by chemically modifying a structure of the parent material. Examples of the pigmentary dispersing agent include sugar-containing pigmentary dispersing agents, piperidyl-containing pigmentary dispersing agents, naphthalene- or perylene-derivative pigmentary dispersing agents, pigmentary dispersing agents having a functional group linked through a methylene group to a pigment parent structure, pigmentary dispersing agents (parent structure) chemically modified with a polymer, pigmentary dispersing agents having a sulfonic acid group, pigmentary dispersing agents having a sulfonamido group, pigmentary dispersing agents having an ether group, and pigmentary dispersing agents having a carboxylic acid group, carboxylic acid ester group or carboxamido group. When a color filter application is taken into consideration, an alkali-soluble polymer dispersing agent is preferably used. A compound represented by formula (I) described in JP-A-2000-239554 is also preferably used.

The amount of the polymer dispersing agent to be added to the organic pigment (when the polymer dispersing agent is used in combination with another dispersing agent, the total amount of the dispersing agents) is preferably from 0.1 to 1,000 parts by mass, more preferably from 1 to 500 parts by mass, and further preferably from 10 to 250 parts by mass, to 100 parts by mass of the organic pigment, to further improve the uniform dispersibility and storage stability of the organic pigment particles. If the amount of the dispersing agent to be added is too small, the dispersion stability of the organic pigment fine particles may not be improved, in some cases.

The above-mentioned nitrogen-containing polymer compound is the most preferable example of the polymer dispersing agent to be added at the time of the formation of the organic pigment particles. The nitrogen-containing polymer compound is added in an amount of preferably 1 to 1,000 parts by mass, more preferably 3 to 700 parts by mass, and particularly preferably 5 to 500 parts by mass with respect to 100 parts by mass of the pigment.

A condition for the poor solvent at the time of the production of the organic pigment particles, that is, upon precipitation and formation of the organic pigment particles is not particularly limited, and can be selected from a range from a normal pressure condition to a subcritical or supercritical condition. The temperature at which the solution is prepared under normal pressure is preferably −30 to 100° C., more preferably −10 to 60° C., or particularly preferably 0 to 30° C.

A method of mixing the organic pigment solution and the poor solvent is not particularly restricted; it is preferable to add one of them to the other while being stirred, and it is particularly preferable to add the organic pigment solution to the poor solvent while being stirred. It is also preferable to add a solution containing a polymer dispersing agent, which is independently prepared, simultaneously or sequentially upon mixing of the organic pigment solution and the poor solvent for the organic pigment.

The stirring rate is preferably 100 to 10,000 rpm, more preferably 150 to 8,000 rpm, and particularly preferably 200 to 6,000 rpm. A pump or the like may be or may not be used for adding. As the adding method, addition to the stirred liquid or addition from outside the stirred liquid may be used; addition to the stirred liquid is preferable. An arbitrary stirring device can be used as long as its number of revolutions can be controlled. A mixer described in JP-B-55-10545 or a stirring device described in JP-A-10-43570 can also be preferably used.

The pigment concentration of the resultant liquid containing reprecipitated organic pigment particles is not particularly limited, as long as organic pigment particles can be prepared, but the amount of the organic pigment particles is preferably 10 to 40,000 mg, more preferably 20 to 30,000 mg, and particularly preferably 50 to 25,000 mg, per 1,000 ml of the dispersion solvent.

As to a particle diameter of the organic pigment particles, an average scale of a group can be digitalized by several measurement methods. There are frequently-used parameters such as mode diameter indicating the maximum value of distribution, median diameter corresponding to the median value in the integral frequency distribution curve, and various average diameters (number-averaged, length-averaged, area-averaged, weight-averaged diameters, volume-averaged diameters, or the like), and the like. In the present invention, the particle diameter means a number-averaged diameter, unless otherwise particularly specified.

The particle diameter of the organic pigment particles (primary particles) according to the present invention is preferably 500 μm or less, more preferably 100 μm or less, and particularly preferably 10 μm or less. Further, in case of preparing nano-meter-size pigment particles, the particle diameter is preferably 1 nm to 1 μm, more preferably 1 to 200 nm, further preferably 2 to 100 nm, and particularly preferably 5 to 80 nm.

Further, in the present invention, a ratio (Mv/Mn) of volume-averaged diameter (Mv) to number-averaged diameter (Mn) is used as the indicator of the degree of the uniformity in particle size (degree of monodispersion of particles uniform in size), unless otherwise particularly specified. The ratio Mv/Mn of the fine particles (primary particles) contained in the pigment-dispersion composition of the present invention is preferably 1.0 to 2.0, more preferably 1.0 to 1.8, and particularly preferably 1.0 to 1.5.

Examples of a method of measuring the particle diameter of the organic pigment particle include a microscopic method, a gravimetric method, a light scattering method, a light shielding method, an electric resistance method, an acoustic method, and a dynamic light scattering method. Of these, the microscopic method and the dynamic light scattering method are particularly preferable. Examples of a microscope to be used in the microscopic method include a scanning electron microscope and a transmission electron microscope. Examples of a particle measuring device according to the dynamic light scattering method include Nanotrac UPA-EX 150 (trade name) manufactured by NIKKISO Co., Ltd., and a dynamic light scattering photometer DLS-7000 series (trade name) manufactured by OTSUKA ELECTRONICS CO., LTD.

In the present invention, the organic pigment particle dispersion is subjected to desalting and condensation, whereby an organic-pigment-particle dispersion suitable for a color filter coating liquid or for ink-jet ink can be produced on an industrial scale.

Hereinafter, a process of condensing the dispersion liquid will be described.

A condensation method is not particularly restricted as long as the organic pigment particle liquid can be concentrated by the method. Examples of a preferable condensation method include: a method involving adding and mixing an extraction solvent to and with the organic pigment particle dispersion liquid, condensing and extracting the organic pigment particles to the extraction solvent phase, and filtering the concentrated extract through a filter or the like, to provide a concentrated pigment particle liquid; a method involving sedimenting the organic pigment particles by centrifugal separation for condensation; a method involving performing desalting and condensation by ultrafiltration; a method involving sublimating a solvent by vacuum freeze-drying for condensation; and a method involving drying a solvent under heat or reduced pressure for condensation. Alternatively, for example, a combination of two or more of these methods is extremely preferably employed.

A pigment concentration in the pigment-dispersion composition before condensation is preferably 10 mass % or less, more preferably 0.01 to 4 mass %, or particularly preferably 0.02 to 3 mass %; after condensation is preferably 1 to 100 mass %, more preferably 5 to 100 mass %, or particularly preferably 10 to 100 mass %.

Hereinafter, a method of concentrating and extracting will be described.

The extraction solvent for use in a process of concentrating and extracting organic pigment particles in the present invention is not particularly limited, but it is preferably a solvent that is substantially incompatible (immiscible) with the dispersion solvent of the organic pigment particle dispersion liquid (e.g., aqueous solvent) (In the present invention, the term “substantially incompatible” means that the compatibility is low, and the solvent is soluble preferably in an amount of 50 wt % or less, and more preferably 30 wt % or less.), and that forms an interface after the extraction solvent is mixed with the dispersion solvent and left still.

In addition, the extraction solvent is preferably a solvent that causes weak aggregation to such a degree that the organic pigment particles can be redispersed in the extraction solvent. In the present invention, weak, redispersible aggregation means that aggregates can be redispersed without applying high shearing force such as by milling or high-speed agitation. Such a state is preferable, because it is possible to prevent strong aggregation that may change the particle size, and to swell the desirable organic pigment particles with the extraction solvent, besides the dispersion solvent such as water can be easily and rapidly removed by filter-filtration.

As the extraction solvents, ester compound solvents, alcohol compound solvents, aromatic compound solvents, and aliphatic compound solvents are preferable; ester compound solvents, aromatic compound solvents, and aliphatic compound solvents are more preferable; ester compound solvents are particularly preferable.

Examples of the ester compound solvents include 2-(1-methoxy) propyl acetate, ethyl acetate, ethyl lactate, and the like. Examples of the alcohol compound solvents include n-butanol, isobutanol, and the like. Examples of the aromatic compound solvents include benzene, toluene, xylene, and the like. Examples of the aliphatic compound solvents include n-hexane, cyclohexane, and the like. The extraction solvent may be a pure solvent of one of the preferable solvents above, while it may be a mixed solvent of multiple solvents.

An amount of the extraction solvent is not particularly limited, as long as the solvent can extract the organic pigment particles, but an amount of the extraction solvent is preferably smaller than an amount of the organic pigment particle dispersion liquid, considering extraction for concentration. When expressed by volume ratio, an amount of the added extraction solvent is preferably in the range of 1 to 100, more preferably in the range of 10 to 90, and particularly preferably in the range of 20 to 80, with respect to 100 of the organic pigment particle dispersion liquid. A too-large amount may results in elongation of the period for concentration, while a too-small amount may cause insufficient extraction and residual pigment particles in the dispersion solvent.

After addition of the extraction solvent, it is preferably agitated well for sufficient mutual contact with the dispersion liquid. Any conventional method may be used for agitation and mixing. A temperature during addition and mixing of the extraction solvent is not particularly limited, but preferably 1 to 100° C. and more preferably 5 to 60° C. Any apparatus may be used for addition and mixing of the extraction solvent as long as it can suitably carry out each step. For example, a separatory funnel-like apparatus may be used.

As the method for ultrafiltration, methods used for desalting and concentrating silver halide emulsion can be used. Examples are those methods described in Research Disclosure, No. 10208 (1972), No. 13122 (1975), No. 16351 (1977) etc. While pressure difference and flow rate, which are important as the operational conditions, can be selected by referring to the characteristic curves mentioned in Haruhiko Oya, “Maku Riyo Gijutsu Handbook (Membrane Utilization Technique Handbook)”, published by Saiwai Shobo (1978), p. 275, it is necessary to find out optimum conditions for treating an organic pigment particle dispersion composition of interest in order to suppress aggregation of particles. As a method for supplementing the solvent lost due to passage through the membrane, there may be employed either the constant volume method where the solvent is continuously supplemented or the batch method where the solvent is intermittently added. The constant volume method is preferred in the present invention because of its relatively shorter desalting treatment time. As the solvent to be supplemented as described above, pure water obtained by ion exchange or distillation is generally used. A dispersing agent or a poor solvent for dispersing agent may be mixed in the pure water. Alternatively, the dispersing agent or the poor solvent for dispersing agent can also be added to the organic pigment particle dispersion.

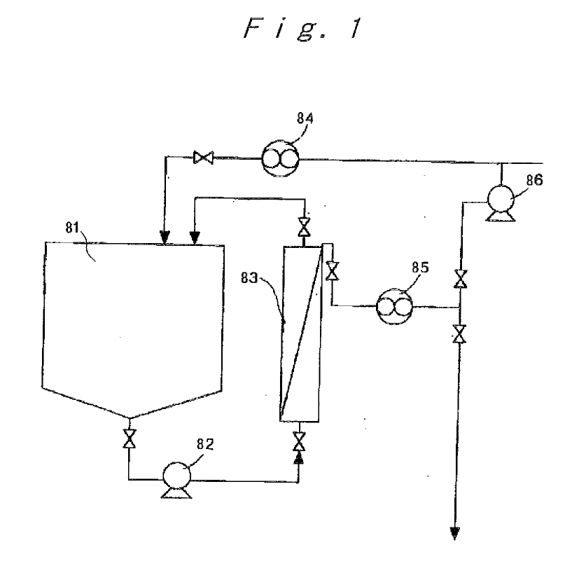

FIG. 1 shows an example of the constitution of a device for performing ultrafiltration. As shown in FIG. 1, the device includes: a tank 81 for storing an organic-pigment-particle dispersion; a circulation pump 82 for circulating the dispersed product in the tank 81; and an ultrafiltration module 83 for removing a by-product in the dispersed product introduced by the circulation pump 82 as permeated water. The dispersed product from which the permeated water has been separated is returned to the inside of the tank 81 again, and a similar operation is repeatedly performed until a predetermined object of the removal of the by-product is achieved. Further, the device is equipped with: a flow meter 84 for measuring replenishment pure water which is used for replenishing the solvent lost by the permeated water by adding a constant amount of pure water; and a flow meter 85 for measuring permeated water which is used for determining the replenishment amount of pure water. In addition, the device is equipped with a reverse direction washing pump 86 for introducing water for diluting the permeated water.

As an ultrafiltration membrane, modules of plate type, spiral type, cylinder type, hollow yarn type, hollow fiber type and so forth, in which a membrane is already incorporated, are commercially available from Asahi Chemical Industry Co., Ltd., Daicel Chemical Industries, Ltd., Toray Industries, Inc., NITTO DENKO CORP. and so forth. In view of the total membrane area, washability, and so forth, those of hollow yarn type and spiral type are preferred. The fractional molecular weight, which is an index of a threshold for substances that can permeate a membrane, must be determined based on the molecular weight of the used dispersing agent. In the present invention, those having a fractional molecular weight of 5,000 to 50,000, more preferably 5,000 to 15,000, are preferably used.

To separate a concentrated extraction liquid from a dispersion solvent of the organic pigment particle dispersion liquid, filtration by using a filter is preferable. The apparatus for filter-filtration is, for example, a high-pressure filtration apparatus. Preferable filters include nanofilter, ultrafilter and the like. It is preferable to remove a residual dispersion solvent by filter filtralation, so as to further concentrate organic pigment particles in the concentrated extract liquid and to obtain a concentrated pigment-particle liquid.

A method for freeze-drying is not particularly limited, and any method may be adopted as long as a person skilled in the art can utilize the method. Examples of the freeze-drying method include a coolant direct expansion method, a multiple freezing method, a heating medium circulation method, a triple heat exchange method, and an indirect heating freezing method. Of these, the coolant direct expansion method or the indirect heating freezing method is preferably employed, and the indirect heating freezing method is more preferably employed. In each method, preliminary freezing is preferably performed before freeze-drying is performed. A condition for freeze-drying is not particularly limited, but a sample to be subjected to freeze-drying must be uniformly frozen.

Examples of a device for the indirect heating freezing method include a small freeze-drying machine, an FTS freeze-drying machine, an LYOVAC freeze-drying machine, an experimental freeze-drying machine, a research freeze-drying machine, a triple heat exchange vacuum freeze-drying machine, a monocooling-type freeze-drying machine, and an HULL freeze-drying machine. Of these, the small freeze-drying machine, the experimental freeze-drying machine, the research freeze-drying machine, or the monocooling-type freeze-drying machine is preferably used, and the small freeze-drying machine or the monocooling-type freeze-drying machine is more preferably used.

A temperature for freeze-drying, which is not particularly limited, is, for example, about −190 to −4° C., preferably about −120 to −20° C., or more preferably about −80 to −60° C. A pressure for freeze-drying is not particularly limited either, and can be appropriately selected by a person skilled in the art. It is recommended that freeze-drying be performed under a pressure of, for example, about 0.1 to 35 Pa, preferably about 1 to 15 Pa, or more preferably about 5 to 10 Pa. A time period for freeze-drying is, for example, about 2 to 48 hours, preferably about 6 to 36 hours, or more preferably about 16 to 26 hours. It should be noted that these conditions can be appropriately selected by a person skilled in the art. With regard to a method for freeze-drying, reference can be made to, for example, Pharmaceutical machinery and engineering handbook by JAPAN SOCIETY OF PHARMACEUTICAL MACHINERY AND ENGINEERING, Chijinshokan Co., Ltd., p. 120-129 (September, 2000), Vacuum handbook by ULVAC, Inc., Ohmsha, Ltd., p. 328-331 (1992), or Freezing and drying workshop paper by Koji Ito et al., No. 15, p. 82 (1965).

Hereinafter, centrifugal separation will be explained. A centrifugal separator for use in the condensation of the organic pigment particles by centrifugal separation may be an arbitrary device as long as the organic pigment particles in the organic pigment particle dispersion liquid (or the organic pigment particle concentrated extract) can be sedimented. Examples of the centrifugal separator include a general-purpose device, a system having a skimming function (function with which a supernatant layer is sucked during the rotation of the system, to discharge to the outside of the system), and a continuous centrifugal separator for continuously discharging solid matter.

As the conditions for centrifugal separation, a centrifugal force (a value representing a ratio of an applied centrifugal acceleration to the gravitational acceleration) is preferably 50 to 10,000, more preferably 100 to 8,000, or particularly preferably 150 to 6,000. A temperature at the time of centrifugal separation is preferably −10 to 80° C., more preferably −5 to 70° C., or particularly preferably 0 to 60° C., though a preferable temperature varies depending on the kind of the solvent of the dispersion liquid.

Hereinafter, drying will be described. A device for use in the condensation of the organic pigment particles by drying under reduced pressure is not particularly limited as long as the solvent of the organic pigment particle dispersion liquid (or the organic pigment particle concentrated extract) can be evaporated. Examples of the device include a general-purpose vacuum drier and a general-purpose rotary pump, a device capable of drying a liquid under heat and reduced pressure while stifling the liquid, and a device capable of continuously drying a liquid by passing the liquid through a tube the inside of which is heated and reduced in pressure.

A temperature for drying under heat and reduced pressure is preferably 30 to 230° C., more preferably 35 to 200° C., or particularly preferably 40 to 180° C. A pressure for the above-mentioned reduced pressure is preferably 100 to 100,000 Pa, more preferably 300 to 90,000 Pa, or particularly preferably 500 to 80,000 Pa.

In the production of the pigment-dispersion composition of the present invention, according to the condensation method as described above, the organic pigment particles can be efficiently concentrated from the organic pigment particle dispersion liquid. A condensation rate is, for example, as follows: when the concentration of the pigment particles in the organic pigment particle dispersion liquid serving as a raw material is set to 1, a concentration in a concentrated organic pigment particle paste can be preferably about 100 to 3,000, or more preferably about 500 to 2,000.

In the pigment-dispersion composition of the present invention, it is preferable that an aggregated pigment-fine-particle liquid is obtained by the pigment-fine-particle dispersion (the aggregated pigment-fine-particle liquid in the present invention refers to a liquid containing an aggregated fine pigment particles and may be a condensate, a paste, slurry, or the like as long as it contains the aggregated fine pigment particles.). In specific, the concentrated and aggregated organic pigment particles are preferably subjected to fine dispersion again in an organic solvent containing a binder at the time of the production of the composition (which may hereinafter be referred to as “redispersion” to a state where the aggregation of the particles in the dispersion liquid is dissolved, to increase the degree of dispersion).

In, for example, a color filter application, the particles can be added to a vehicle before dispersion. The vehicle means a portion of a medium in which a pigment is dispersed when a paint is in a liquid state. The vehicle is a liquid state, and contains a portion (binder) that is bonded to the pigment to solidify a coating film and a component (organic solvent) for dissolving and diluting the portion. In the present invention, a binder to be used at the time of the formation of the organic pigment particles and a binder to be used in redispersion may be identical to or different from each other, and they are separately referred to as a pigment particle formation binder and a redispersion binder, respectively.

In the concentrated, extracted pigment particle liquid described above, in a state of enabling quick filtration through a filter, the organic pigment particles generally aggregate due to condensation. In addition, the organic pigment particles concentrated by centrifugal separation or drying also aggregate due to condensation.

Examples of a method that can be employed for dispersing such aggregated pigment particles (the term “aggregated pigment particles” as used herein refers to those in which pigment particles assemble due to secondary force, such as an aggregate), include a method for dispersion with a supersonic wave and a method involving applying physical energy.

Apparatus of ultrasonic wave irradiation that can be used in the present invention is preferably an apparatus that is capable of applying an ultrasonic wave at 10 kHz or more, and examples thereof include an ultrasonic wave homogenizer, an ultrasonic wave cleaning machine, and the like. A liquid temperature during ultrasonic wave irradiation is preferably kept at 1 to 100° C., more preferably 5 to 60° C., since increase in the liquid temperature leads to thermal aggregation of pigment particles (see “Current Pigment Dispersion Technology”, Technical Information Institute Co., Ltd., 1995, p. 166). The temperature can be controlled, for example, by adjusting the temperature of dispersion liquid, by adjusting the temperature of the temperature-controlling layer for controlling of dispersion liquid temperature, or the like.

A dispersion machine to be used upon dispersion of the concentrated organic pigment particles by the application of physical energy is not particularly limited, and examples of the dispersion machine include a kneader, a roll mill, an attritor, a super mill, a dissolver, a homomixer, and a sand mill.

It is also preferable to use a compound shown in the section titled (Dispersing agent at the time of formation of organic pigment particles) again as a dispersing agent to be used at the time of redispersion.

In the pigment-dispersion composition of the present invention, the graft polymer is particularly preferably used at the time of redispersion. The graft polymer is preferably added in an amount as described in the above.

In addition, prior to the addition of the graft polymer, it is also preferable to add the pigment-based pigment dispersing agent. The pigment-based dispersing agent is added in an amount of preferably 0.1 to 100 parts by mass, or particularly preferably 1 to 50 parts by mass, with respect to 100 parts by mass of the pigment.

In the pigment-dispersion composition of the present invention, the organic pigment particles (primary particles) after redispersion can be particles subjected to fine dispersion, and the particle diameter of an individual particle can be preferably 1 to 200 nm, more preferably 2 to 100 nm, or particularly preferably 5 to 50 nm. In addition, the ratio My/Mn of the particles after redispersion is preferably 1.0 to 2.0, more preferably 1.0 to 1.8, or particularly preferably 1.0 to 1.5.

The organic pigment particles contained in each of the pigment-dispersion composition and colored photosensitive composition of the present invention are concentrated and redispersed at a target particle size irrespective of their minute particle diameters as small as a nanometer size (for example, 10 to 100 nm). Accordingly, the use of each of the compositions in a color filter can show a high optical density, provide the surface of the filter with excellent uniformity, show a high contrast, and reduce the noise of an image.

Further, the organic pigment particles in each of the pigment-dispersion composition and colored photosensitive composition of the present invention are dispersed in fine-particle states of being highly and uniformly reduced in size. Accordingly, a film formed of each of the compositions exerts a high coloring concentration even when the film has a small thickness, thereby enabling a reduction in thickness of, for example, a color filter.

In addition, each of the pigment-dispersion composition and colored photosensitive composition of the present invention is useful as an image forming material for producing, for example, a color proof or a color filter, when a pigment showing a clear color tone and high coloring power is incorporated into each of the compositions.

Further, each of the pigment-dispersion composition and colored photosensitive resin composition of the present invention uses a binder which is soluble in an alkaline aqueous solution even for an alkaline developer for use in exposure and development at the time of the formation of a colored image, thus each of the compositions can meet the need for environment protection.

In addition, an organic solvent having a suitable drying property can be used as a solvent (a dispersion medium for a pigment) for use in each of the pigment-dispersion composition and colored photosensitive composition of the present invention, and the resultant compositions of the present invention can satisfy the need in drying after coating the compositions.

A colored photosensitive composition is generally constituted of a pigment and a photosensitive composition. Examples of the photosensitive composition include photosensitive compositions described in JP-A-3-282404, and specific examples of the composition include: a photosensitive composition composed of a negative diazo resin and a binder; a photopolymerizable composition; a photosensitive composition composed of an azide compound and a binder; and a cinnamic acid type photosensitive composition. The photosensitive composition is known to be of a type that can be developed with an alkali aqueous solution or a type that can be developed with an organic solvent; the composition is preferably of a type that can be developed with an alkali aqueous solution in terms of, for example, anti-pollution and occupational safety.

Among these photosensitive compositions, the colored photosensitive composition of the present invention is a photopolymerizable composition containing at least: a polyfunctional monomer having two or more ethylenically unsaturated double bonds; and a photopolymerization initiator.

Therefore, the colored photosensitive composition of the present invention contains at least: the organic pigment and the graft polymer having an acid group, that is, the pigment-dispersion composition according to the present invention; the polyfunctional monomer having two or more ethylenically unsaturated double bonds; and the photopolymerization initiator. It should be noted that the composition may contain a binder polymer having an acid group. In addition, the composition can preferably contain a pigment dispersing agent particularly when an organic pigment using no surface modifier is used as the organic pigment serving as a raw material for the formation of the pigment particles. The colored photosensitive composition of the present invention preferably contains, with respect to the total solid content, the solid content of the pigment-dispersion composition (i.e. the content of the fine pigment particles) in an amount of preferably 40 to 90 mass %.

Examples of the polyfunctional monomer having two or more ethylenically unsaturated double bonds include known (meth)acrylates, urethane (meth)acrylate, (meth)acrylic acid amides, allyl compounds, and vinyl esters described in, for example, JP-A-60-258539. One kind of them may be used alone, or two or more kinds of them may be used in combination. Of these, the (meth)acrylates are preferable.

The content of the polyfunctional monomer having two or more ethylenically unsaturated double bonds in the colored photosensitive composition is preferably 10 to 60 mass % with respect to the total solid content. When the content is too small, the hardening power of the composition at the time of exposure is insufficient in some cases. When the content is too large, an ability of other materials is hardly exerted in some cases.

As the photopolymerization initiator, use can be preferably made of at least one kind of a compound having a molecular absorption coefficient of at least about 50 in the wavelength range of about 300 to 500 nm. Examples of the compound include aromatic ketones, lophine dimers, benzoin, benzoin ethers, and polyhalogens, as described in JP-A-02-48664, JP-A-01-152449, and JP-A-02-153353. One kind of the compounds may be used singly, or two or more kinds of them may be used in combination. Of these, a combination of 4,4′-bis(diethylamino)benzophenone and a 2-(o-chlorophenyl)-4,5-diphenylimidazole dimer, and 4-(p-N,N-di(ethoxycarbonylmethyl)-2,6-di(trichloromethyl)-s-triazine) are preferable.

The content of the photopolymerization initiator in the colored photosensitive composition is preferably 0.2 to 20 mass % with respect to the total solid content of the colored photosensitive composition. When the content is too small, the exposure sensitivity of the composition results to be low in some cases. When the content is too large, the exposure sensitivity becomes too high (so as to be difficult to control) in some cases.

The colored photosensitive composition can be prepared by, for example, mixing the pigment-dispersion composition and the photosensitive composition, under an appropriately selected condition, according to an appropriately selected procedure.

A colored image can be basically formed by using the colored photosensitive composition through the following steps (1) to (3):

(1) a step involving: preparing the pigment-dispersion composition, and then preparing the colored photosensitive composition by using the pigment-dispersion composition;
(2) a step involving: applying the resultant colored photosensitive composition onto a substrate and drying the composition, to form the layer of the colored photosensitive composition; or alternatively involving: transferring a layer, which is formed by applying the composition onto another temporary support and by drying the composition, onto the substrate, to form the layer of the colored photosensitive composition on the substrate; and
(3) a step involving: subjecting the layer of the colored photosensitive composition formed on the substrate, to exposure and development, to form a pattern.

In addition, examples of the binder polymer having an acid group, which can be used in the colored photosensitive composition of the present invention, include compounds similar to those described above as the examples of the binder polymer in the pigment-dispersion composition of the present invention. When the composition contains the binder polymer, the colored photosensitive composition preferably contains the binder polymer at a content of 5 to 35 mass % with respect to the total solid content of the composition.

A color filter for use in, for example, a liquid crystal display can be produced by repeatedly performing the above-mentioned steps (2) and (3), and by combining second and subsequent color patterns. A method of producing a color filter by a transfer method is described in, for example, JP-A-04-208940, JP-A-05-72724, JP-A-05-80503, and JP-A-05-173320.

As the substrate, a transparent material such as a glass plate or a transparent plastic plate is generally used. In order to enhance an adhesive force between the substrate and the colored photosensitive composition, any one of various commercially available silane coupling agents and the like may be added to the colored photosensitive composition, or the substrate may be subjected to a coupling treatment in advance.

The application liquid of the colored photosensitive composition can be applied to the substrate, by using any applying means such as a spin coater, a roll coater, a bar coater, or a curtain coater.

A preferable example of a method of transferring the layer of the colored photosensitive composition formed on the temporary support onto the substrate, is a method involving using a heat roll laminator under normal or reduced pressure.

Examples of a developer to be used at the time of the development include: an aqueous solution of a hydroxide, carbonate, or hydrogen carbonate of an alkali metal or alkali earth metal; ammonia water; and an aqueous solution of a quaternary ammonium salt. One kind of the developer may be used singly, or two or more kinds of them may be used in combination. Of these, an aqueous solution of sodium carbonate is particularly preferable.

The present invention will be described in more detail based on the following examples, but the present invention is not limited thereto.

### EXAMPLES

### Example 1

3,3 ml of a 28% solution of sodium methoxide in methanol, 6,000 mg of a pigment (Pigment Red 254), 6,000 mg of polyvinyl pyrrolidone, and 600 mg of a pigment dispersing agent A were added to 100 ml of dimethyl sulfoxide, to prepare a pigment solution A.

Separately, 1,000 ml of water containing 16 ml of 1-mol/l hydrochloric acid was prepared as a poor solvent.

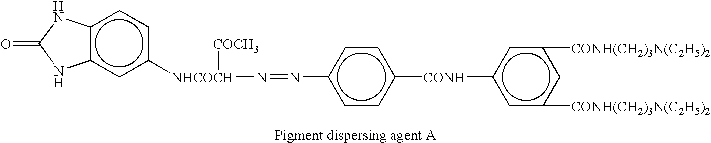

200 ml of the pigment solution A were injected at a flow rate of 50 ml/min by using an NP-KX-500 large-volume nonpulsating pump manufactured by Nippon Fine Chemical into 1,000 ml of the water as the poor solvent whose temperature had been controlled to 1° C. and which had been stirred with a GK-0222-10 Ramond stirrer (trade name, manufactured by Astellas Pharma Inc. (the former Fujisawa Pharmaceutical Co., Ltd.)), at 500 rpm, whereby organic pigment particles were formed, and a pigment dispersion liquid was prepared. The particle diameter and degree of monodispersion of the pigment dispersion liquid were measured with a Nanotrac UPA-EX 150 manufactured by NIKKISO Co., Ltd. As a result, the liquid had a number average particle diameter of 32 nm and a ratio Mv/Mn of 1.35.

The prepared pigment dispersion liquid (having an organic pigment concentration of about 0.5 mass %) was added with 500 ml of 2-(1-methoxy)propylacetate, and the whole was stirred at 25° C. for 10 minutes at 500 rpm. After that, the resultant was left standing for 1 day, and a nanopigment was extracted to a 2-(1-methoxy)propylacetate phase, whereby a concentrated extract liquid was obtained.

The concentrated extract liquid containing the extracted organic pigment was filtered by using an FP-010 filter manufactured by SUMITOMO ELECTRIC FINE POLYMER INC., whereby a paste-like concentrated pigment liquid (having an organic pigment concentration of 35 mass %) was obtained. The amount of polyvinyl pyrrolidone in the paste-like concentrated pigment liquid was 19 mass % with respect to the organic pigment.

A pigment-dispersion composition A having the following composition was prepared by using the above paste-like concentrated pigment liquid.

| | |
|---|---|
| The aforementioned paste-like concentrated | 18.3 g |
| pigment liquid | |
| Pigment dispersing agent A | 0.6 g |
| Polymer A (copolymer) in Synthesis Example 1 | 3.2 g |
| 1-methoxy-2-propylacetate | 42.0 g |

The pigment composition having the above composition was dispersed with a motor mill M-50 (manufactured by Igar), by using zirconia beads each having a diameter of 0.65 mm, at a circumferential speed of 9 m/s for 1 hour.

The resultant pigment-dispersion composition was evaluated for the following items.

(1) Viscosity measurement: the viscosity of the resultant pigment-dispersion composition 1 day after the preparation was measured by using an E type viscometer, and the composition was evaluated for degree of thickening. Table 1 shows the result.

(2) Contrast measurement: the resultant pigment-dispersion composition was applied onto a glass substrate in such a manner that the thickness of the composition after drying would be 1 μm, whereby a sample was prepared. The sample was placed between two polarizing plates, and the quantity of light that transmitted through the sample when polarization axes were parallel to each other and the quantity of light that transmitted through the sample when the polarization axes were perpendicular to each other were measured. A ratio of the quantity of light that transmitted through the sample when the polarization axes of the polarizing plates were parallel to each other to the quantity of light that transmitted through the sample when the polarization axes of the polarizing plates were perpendicular to each other was defined as a contrast (reference was made to “The Seventh Calorific Optics Conference, 1990, color filter for TFT-LCD of 512-color and 10.4″-size by Ueki, Ozeki, Fukunaga, and Yamanaka”). Table 1 shows the result.

### Example 2

A pigment-dispersion composition was prepared in the same manner as in Example 1 except that a polymer B in Synthesis Example 2 was used in place of the polymer A, and the composition was evaluated in the same manner as in Example 1.

### Example 3

A pigment-dispersion composition was prepared in the same manner as in Example 1 except that a polymer C in Synthesis Example 3 was used in place of the polymer A, and the composition was evaluated in the same manner as in Example 1.

### Example 4

A pigment-dispersion composition was prepared in the same manner as in Example 1 except that a polymer D was used in place of the polymer A, and the composition was evaluated in the same manner as in Example 1. It should be noted that the polymer D is a copolymer of the above polymerizable monomer-1 and a Macromonomer AA-6 (copolymerization ratio in terms of mass 10:90, mass average molecular weight 20,000).

### Example 5

A pigment-dispersion composition was prepared in the same manner as in Example 1 except that a polymer E was used in place of the polymer A, and the composition was evaluated in the same manner as in Example 1. It should be noted that the polymer E is a copolymer of the above polymerizable monomer-2 and a Macromonomer AA-6 (copolymerization ratio in terms of mass 10:90, mass average molecular weight 20,000).

### Example 6

A pigment-dispersion composition was prepared in the same manner as in Example 1 except that the pigment dispersing agent A was not added at the time of dispersion, and the composition was evaluated in the same manner as in Example 1.

### Example 7

A pigment-dispersion composition was prepared in the same manner as in Example 1 except that a mixture of 1.6 g of polymer B and 1.6 g of polymer C was used in place of 3.2 g of the polymer A, and the composition was evaluated in the same manner as in Example 1.

### Example 8

A pigment-dispersion composition was prepared in the same manner as in Example 1 except that a polymer F was used in place of the polymer A, and the composition was evaluated in the same manner as in Example 1. It should be noted that the polymer F is a copolymer of methacrylic acid and a Macromonomer AA-6 (copolymerization ratio in terms of mass 5:95, mass average molecular weight 20,000).

### Example 9

A pigment-dispersion composition was prepared in the same manner as in Example 1 except that a polymer G was used in place of the polymer A, and the composition was evaluated in the same manner as in Example 1. It should be noted that the polymer G is a copolymer of methacrylic acid and a Macromonomer AA-6 (copolymerization ratio in terms of mass 20:80, mass average molecular weight 20,000).

### Example 10

A pigment-dispersion composition was prepared in the same manner as in Example 1 except that a polymer H was used in place of the polymer A, and the composition was evaluated in the same manner as in Example 1. It should be noted that the polymer H is a copolymer of methacrylic acid and a Macromonomer AA-3 (manufactured by TOAGOSEI CO., LTD., having a structure similar to that of AA-6 and a number average molecular weight of 3,000) (copolymerization ratio in terms of mass 10:90, mass average molecular weight 20,000).

### Example 11

A pigment-dispersion composition was prepared in the same manner as in Example 1 except that a polymer I was used in place of the polymer A, and the composition was evaluated in the same manner as in Example 1. It should be noted that the polymer I is a copolymer of methacrylic acid and a Macromonomer AA-10 (manufactured by TOAGOSEI CO., LTD., having a structure similar to that of AA-6 and a number average molecular weight of 10,000) (copolymerization ratio in terms of a weight 10:90, mass average molecular weight 20,000).

### Example 12

A pigment-dispersion composition was prepared in the same manner as in Example 1 except that a polymer J was used in place of the polymer A, and the composition was evaluated in the same manner as in Example 1. It should be noted that the polymer J is a copolymer of methacrylic acid and a Macromonomer AA-6 (copolymerization ratio in terms of a weight 10:90, mass average molecular weight 10,000).

### Example 13

A pigment-dispersion composition was prepared in the same manner as in Example 1 except that a polymer K was used in place of the polymer A, and the composition was evaluated in the same manner as in Example 1. It should be noted that the polymer K is a copolymer of methacrylic acid and a Macromonomer AA-6 (copolymerization ratio in terms of a weight 10:90, mass average molecular weight 70,000).

### Comparative Example 1

A pigment-dispersion composition was prepared in the same manner as in Example 1 except that a methacrylic acid/benzyl methacrylate copolymer (molar ratio 28/72, mass average molecular weight 30,000) was used in place of the polymer A, and the composition was evaluated in the same manner as in Example 1.

### Comparative Example 2

A pigment-dispersion composition was prepared in the same manner as in Comparative Example 1 except that the pigment dispersing agent A was not added at the time of dispersion, and the composition was evaluated in the same manner as in Example 1.

### Example 14

The following compositions were mixed to prepare a colored photosensitive composition for producing a color filter.

| | |
|---|---|
| Pigment-dispersion composition of Example 1 | 32.0 g |
| Methacrylic acid/benzyl methacrylate copolymer | 1.0 g |
| (molar ratio 28/72, mass average molecular | |
| weight 30,000, 30% 1-methoxy-2-propylacetate solution) | |
| Pentaerythritol tetraacrylate | 5.2 g |
| 4-[p-N,N-di(ethoxycarbonylmethyl)]-2,6- | 0.2 g |
| di(trichloromethyl)-5-triazine | |
| Hydroquinone monomethyl ether | 0.01 g |
| 1-methoxy-2-propylacetate | 62 g |

A color filter was produced from the resultant colored photosensitive composition for producing a color filter in the manner as described below, and its contrast was measured in the same manner as in Example 1. It should be noted that the coating thickness was 2 μm. Table 1 shows the result.

Specifically, the colored photosensitive composition for producing a color filter was applied onto a glass substrate by using a spin coater, and the applied composition was dried at 100° C. for 2 minutes, whereby a film having a thickness of about 2 μm was formed. Next, the resultant was exposed to light from an ultra-high pressure mercury lamp in a stream of nitrogen, and was then developed with a 1% aqueous solution of sodium carbonate. The contrast of the resultant color filter was measured in the same manner as in Example 1.

### Example 15

A colored photosensitive composition was prepared in the same manner as in Example 14 except that the pigment-dispersion composition of Example 2 was used in place of the pigment-dispersion composition of Example 1, and the colored photosensitive composition was evaluated in the same manner as in Example 14.

### Example 16

A colored photosensitive composition was prepared in the same manner as in Example 14 except that the pigment-dispersion composition of Example 3 was used in place of the pigment-dispersion composition of Example 1, and the colored photosensitive composition was evaluated in the same manner as in Example 14.

### Example 17

A colored photosensitive composition was prepared in the same manner as in Example 14 except that the pigment-dispersion composition of Example 4 was used in place of the pigment-dispersion composition of Example 1, and the colored photosensitive composition was evaluated in the same manner as in Example 14.

### Example 18

A colored photosensitive composition was prepared in the same manner as in Example 14 except that the pigment-dispersion composition of Example 5 was used in place of the pigment-dispersion composition of Example 1, and the colored photosensitive composition was evaluated in the same manner as in Example 14.

### Example 19

A colored photosensitive composition was prepared in the same manner as in Example 14 except that the pigment-dispersion composition of Example 6 was used in place of the pigment-dispersion composition of Example 1, and the colored photosensitive composition was evaluated in the same manner as in Example 14.

### Example 20

A colored photosensitive composition was prepared in the same manner as in Example 14 except that the pigment-dispersion composition of Example 7 was used in place of the pigment-dispersion composition of Example 1, and the colored photosensitive composition was evaluated in the same manner as in Example 14.

### Example 21

A colored photosensitive composition was prepared in the same manner as in Example 14 except that the pigment-dispersion composition of Example 8 was used in place of the pigment-dispersion composition of Example 1, and the colored photosensitive composition was evaluated in the same manner as in Example 14.

### Example 22

A colored photosensitive composition was prepared in the same manner as in Example 14 except that the pigment-dispersion composition of Example 9 was used in place of the pigment-dispersion composition of Example 1, and the colored photosensitive composition was evaluated in the same manner as in Example 14.

### Example 23

A colored photosensitive composition was prepared in the same manner as in Example 14 except that the pigment-dispersion composition of Example 10 was used in place of the pigment-dispersion composition of Example 1, and the colored photosensitive composition was evaluated in the same manner as in Example 14.

### Example 24

A colored photosensitive composition was prepared in the same manner as in Example 14 except that the pigment-dispersion composition of Example 11 was used in place of the pigment-dispersion composition of Example 1, and the colored photosensitive composition was evaluated in the same manner as in Example 14.

### Example 25

A colored photosensitive composition was prepared in the same manner as in Example 14 except that the pigment-dispersion composition of Example 12 was used in place of the pigment-dispersion composition of Example 1, and the colored photosensitive composition was evaluated in the same manner as in Example 14.

### Example 26

A colored photosensitive composition was prepared in the same manner as in Example 14 except that the pigment-dispersion composition of Example 13 was used in place of the pigment-dispersion composition of Example 1, and the colored photosensitive composition was evaluated in the same manner as in Example 14.

### Comparative Example 3

A colored photosensitive composition was prepared in the same manner as in Example 14 except that the pigment-dispersion composition of Comparative Example 1 was used in place of the pigment-dispersion composition of Example 1, and the colored photosensitive composition was evaluated in the same manner as in Example 14.

### Comparative Example 4

A colored photosensitive composition was prepared in the same manner as in Example 14 except that the pigment-dispersion composition of Comparative Example 2 was used in place of the pigment-dispersion composition of Example 1, and the colored photosensitive composition was evaluated in the same manner as in Example 14.

TABLE 1

| | | Contrast | |
|---|---|---|---|
| | Viscosity of pigment- | Film of pigment- | Film of colored |
| | dispersion | dispersion | photosensitive |
| | composition (cP) | composition | composition |
| Example 1 | 30 | 5000 | — |
| Example 2 | 40 | 4500 | — |
| Example 3 | 25 | 5000 | — |
| Example 4 | 20 | 5250 | — |
| Example 5 | 15 | 5500 | — |
| Example 6 | 80 | 4000 | — |
| Example 7 | 35 | 4500 | — |
| Example 8 | 25 | 5500 | — |
| Example 9 | 70 | 3500 | — |
| Example 10 | 100 | 3000 | — |
| Example 11 | 55 | 4000 | — |
| Example 12 | 40 | 4250 | — |
| Example 13 | 110 | 3750 | — |
| Example 14 | — | — | 5000 |
| Example 15 | — | — | 4750 |
| Example 16 | — | — | 4750 |
| Example 17 | — | — | 5000 |
| Example 18 | — | — | 5750 |
| Example 19 | — | — | 4000 |
| Example 20 | — | — | 4500 |
| Example 21 | — | — | 5750 |
| Example 22 | — | — | 3000 |
| Example 23 | — | — | 2750 |
| Example 24 | — | — | 4000 |
| Example 25 | — | — | 4250 |
| Example 26 | — | — | 4000 |
| Comparative | 300 | 300 | — |
| example 1 | | | |
| Comparative | 500 | 250 | — |
| example 2 | | | |
| Comparative | — | — | 350 |
| example 3 | | | |
| Comparative | — | — | 300 |
| example 4 | | | |

As is apparent from the results of Table 1, the pigment-dispersion composition of the present invention and the colored photosensitive compositions using the compositions each showed a low viscosity and a high contrast. It can be considered that a high contrast was obtained probably because the pigment particles in the composition of the present invention were each dispersed in a finely dispersed state.

The reagents used are specifically the followings:

| Reagent | Manufacturer |
|---|---|
| Pigment Red 254 | Ciba Specialty Chemicals company |
| (Irgaphore Red) | |
| 1-Methyl-2-pyrrolidone | Wako Pure Chemical Industries, Ltd. |
| 2-(1-Methoxy) propyl acetate | Wako Pure Chemical Industries, Ltd. |
| Dimethylsulfoxide | Wako Pure Chemical Industries, Ltd. |
| Methanol solution of 28% | Wako Pure Chemical Industries, Ltd. |
| sodium methoxide | |

### INDUSTRIAL APPLICABILITY

The pigment-dispersion composition and colored photosensitive composition of the present 0.5 invention can show good dispersibility and fluidity with high coloring power, and hence they can be suitably applied in industrial applications including paints, printing inks, and color displays.

Having described our invention as related to the present embodiments, it is our intention that the invention not be limited by any of the details of the description, unless otherwise specified, but rather be construed broadly within its spirit and scope as set out in the accompanying claims.

This non-provisional application claims priority on Patent Application No. 2006-031483 filed in Japan on Feb. 8, 2006, which is herein incorporated by reference.

1. A pigment-dispersion composition, comprising:
a graft polymer having an acid group and
organic pigment particles formed by mixing a solution in which an organic pigment is dissolved in a good solvent with a poor solvent for the organic pigment, the poor solvent having compatibility with the good solvent.

2. The pigment-dispersion composition according to claim 1, wherein the graft polymer is a copolymer which is formed at least by copolymerization components comprising a polymerizable monomer component having the acid group and a polymerizable oligomer component having an ethylenically unsaturated double bond at any one of its terminals.

3. The pigment-dispersion composition according to claim 2, wherein the graft polymer comprises 15 to 98 mass % of a unit derived from the polymerizable oligomer and 1 to 40 mass % of a unit derived from the polymerizable monomer having the acid group.

4. The pigment-dispersion composition according to claim 2, wherein the polymerizable oligomer has a number-average molecular weight of 1,000 to 20,000, and the oligomer has a (meth)acryloyl group at any one of its terminals.

5. The pigment-dispersion composition according to claim 2, wherein the composition comprises the graft polymer in an amount of 10 to 80 parts by mass with respect to 100 parts by mass of the organic pigment.

6. The pigment-dispersion composition according to claim 1, further comprising a nitrogen-containing polymer.

7. The pigment-dispersion composition according to claim 6, wherein the nitrogen-containing polymer is water-soluble.

8. The pigment-dispersion composition according to claim 1, wherein the organic pigment particles are dispersed in an organic solvent.

9. The pigment-dispersion composition according to claim 1, wherein the acid group is a group selected from the group consisting of a carboxyl group and a phosphoric acid group.

10. A colored photosensitive composition, comprising: the composition according to claim 1, a polyfunctional monomer having two or more ethylenically unsaturated double bonds, and a photopolymerization initiator.
